(19) United States
(12) Patent Application Publication
(10) Pub. No.: US 2014/0090293 A1
(43) Pub. Date: Apr. 3, 2014

(54) Partnering mirrors and reflective material with growing lights to enhance plant growth for maximizing indoor plant production

(71) Applicant: Brian Edgar Walker, Malvern, IA (US)

(72) Inventor: Brian Edgar Walker, Malvern, IA (US)

(21) Appl. No.: 13/998,029

(22) Filed: Sep. 24, 2013

Related U.S. Application Data
(60) Provisional application No. 61/708,209, filed on Oct. 1, 2012.

(51) Int. Cl. A01G 7/04

(52) U.S. Cl. CPC A01G 7/045
USPC 47/58.1 LS

(57) ABSTRACT

Agribusiness like most markets is very competitive. In particular, agricultural products that have a short shelf life create an added pressure to sell and ship more quickly. By using mirrors and other reflective material, the cost of production is reduced, while improving the quality and quantity of plant production. This process of using mirrors and reflective material improves plant growth and production beyond other indoor or outdoor growing systems. This process may be the most efficient system by growing plants in a sterile, pesticide-free, and easily accessible facility, significantly reducing labor costs. By controlling every facet of the growing process, commercial production can occur in virtually any kind of outdoor weather conditions, while making best use of land and natural resources, potentially affecting agribusiness globally. Because this process has national and global consequences, the use of mirrors and reflective material for plant production needs to be patented.

### BACKGROUND OF THE INVENTION

The growing, shipping, and selling of raw foods typically falls into two separate and distinct camps, organic and conventional growers. Organic growers supply a need to consumers that demand the use “natural” growing techniques. However, for the organic growers, the cost to grow and ship these products tends to be higher than conventional methods. These costs can be associated with lower yields than conventional methods because of higher pest populations, fungal and soil diseases. Organic growers have limited, costly resources, such as certified “natural” pest control and fungal products; fighting these battles against nature can produce lower yields with higher production costs. Attaining and maintaining organic certification by using authorized seeds and fertilizers, usually leads to higher costs. Even though evidence is far from certain that organic products are healthier for the consumer, these products will likely remain as an alternative source for those that are willing to buy these higher priced items.

In contrast, conventional growing is still by far the most common method for raw foods production. With this process, advanced technical methods such as engineering seeds that are more resistant to soil fungus and viruses, the use of chemicals for fungus and pest control, and cheap man-made fertilizers are used to achieve the most yields for the grower. In essence, all known options are used to maximize yields thus providing a relatively cheap product to market.

Using greenhouses for commercial crop production is a well-established process and can be set up using organic or traditional methods. The distinct advantage that greenhouses provide is the ability to extend the growing season in certain regions. The weather in many regions allows greenhouse production to be profitable year-round. However, there are many disadvantages. First, greenhouses are not productive in all areas. For example, when growing cold crops in hot climates it is nearly impossible to produce a quality product at an affordable price. Second, in northern regions, the winter months provides less than ideal growing conditions due to poor sunlight, requiring expensive temporarily lighting. Managing a year-round greenhouse operation is fraught with serious challenges. Greenhouses rely on sunlight for lighting and plant growth. They are poorly insulated, therefore hot and cold weather patterns can greatly affect needs for heating and cooling. Third, pest control can be a major problem. In fact, pest control can be more difficult in greenhouses than with outside crop production. Pests can flourish since they have no predators inside a greenhouse. Greenhouses can create microenvironments in which certain pests can grow and attacks crops with no opposing enemy. This may require using more chemicals to control pest populations. Since greenhouses are not completely insulated from the outside, pests can continue to penetrate and with more chemicals, pests may develop immunities to pesticides. For organic greenhouse growers, pest problems are just as difficult to control and costly. Fourth, greenhouse growers (and outside growers) need land to expand. From a business growth perspective, they become limited to the amount of land they possess.

Contamination in raw foods is a major problem that has killed many Americans. When contamination is linked to a particular farm, the reputation of that business is at risk. Both organic and traditional growing techniques are vulnerable to contaminates in the soil and air by insects, animals, and humans. Therefore, food security will increasingly become important to most Americans. Future companies that can guarantee food security will have a distinct advantage over the rest of the global food companies. The invention relates to using artificial lighting to stimulate indoor plant growth.

Initial experiments have resulted in better than expected results. Mirrors and reflective materials were used on a small scale to help increase illumination and direct light toward multiple plant surfaces to maximize light absorption. Plants were grown in a sterile structural environment, controlling nearly all facets of the growing process. By growing plants in a controlled environment, quality and quantity is predictable as compared to outdoor or greenhouse production methods. Additionally, labor costs were controlled better than with traditional growing methods because harvests were consistent requiring fewer laborers. Because the work was inside an environmentally controlled facility, the labor was less physically demanding than traditional growing methods. Initial results revealed shelf life from harvest was higher than outdoor or greenhouse production methods. These experimental plants received more light than without the use if reflective material. By using reflective material, this process can produce more light than plants would receive when grown in a common greenhouse facility or outdoors. Traditional processes must rely on the sunlight, which is inconsistent, and at times, an incomplete source of light. Lastly, because plant production is indoors, growing on a large scale is affordable. Structures can be built vertically making an efficient use of land and natural resources.

### BRIEF SUMMARY OF THE INVENTION

Plants will be grown in a structure with interior reflective surfaces. Growing lights will be positioned to illuminate all reflective surfaces towards plants to enhance light availability.

### DETAILED DESCRIPTION OF THE INVENTION

A newly constructed or existing structure will be outfitted with mirrors and reflective material. Mirrors and reflective material will be attached to the ceiling and all walls. Reflective paint or other reflective materials would surface the floor. Growing lights will be placed throughout the structure to illuminate all reflective surfaces maximizing the plants' light absorption.

1. The claimed is—The use of reflective surfaces/mirrors on the walls, ceiling, and floor in conjunction with growing lights to maximize light absorption by the plants.
